(19) United States
(12) Patent Application Publication
(10) Pub. No.: US 2020/0410824 A1
(43) Pub. Date: Dec. 31, 2020

(54) MANAGEMENT OF AN AUTOMATED TELLER MACHINE (ATM) WITH A CORRESPONDING QUEUE OF USERS

(71) Applicant: International Business Machines Corporation, Armonk, NY (US)

(72) Inventors: Mandar Dattatraya Bhuvad, Pune (IN); Manish Madhukarrao Tumbde, Pune (IN); Sreenath Raghunath, Pune (IN); Nitesh Jankilal Shreemali, Pune (IN); Girish Padmanabhan, Pune (IN)

(21) Appl. No.: 16/451,219

(22) Filed: Jun. 25, 2019

(51) Int. Cl. G07F 19/00; G06F 16/2455; G06Q 20/10; G06K 9/00

(52) U.S. Cl. CPC G07F 19/206; G06F 16/2455; G06K 9/00288; G07F 19/207; G06Q 20/1085

(57) ABSTRACT

Aspects of the present invention disclose a method for determining and providing information to users in queue at an ATM based on actual and estimated resource usage of the ATM. The method includes one or more processors identifying a plurality of users in a queue at an automated teller machine (ATM). The method further includes determining historical ATM usage information associated with the identified plurality of users in the queue at the ATM. The method further includes determining respective ATM transaction estimates for the plurality of users in the queue at the ATM based on the determined historical ATM usage information. The method further includes determining respective transaction completion probabilities for the identified plurality of users completing the respective ATM transaction estimates based on a current resource supply of the ATM and the determined historical ATM usage information of the plurality of users in the queue at the ATM.

### BACKGROUND OF THE INVENTION

The present invention relates generally to the field of data analytics, and more particularly to automated teller machine (ATM) analysis and management.

An automated teller machine (ATM) is an electronic telecommunications device that enables customers of financial institutions to perform financial transactions, such as cash withdrawals, deposits, transfer funds, or obtaining account information, without the need for direct interaction with bank staff. ATMs are known by a variety of names, including automatic teller machine (ATM) (e.g., in the United States), often redundantly ATM machine, automated banking machine (ABM) (e.g., in Canada), cash point, cash machine, minibank, etc.

Using an ATM, customers can access their bank deposit or credit accounts in order to make a variety of financial transactions most notable cash withdrawals but also check balances, or credit mobile phones. ATMs can be used to withdraw cash in a foreign country. Customers are typically identified by inserting a plastic ATM card (or some other acceptable payment card) into the ATM, with authentication being by the customer entering a personal identification number (PIN), which must match the PIN stored in the chip on the card (if the card is so equipped), or in the issuing financial institution's database. Customers can also interface with an ATM (or a network of a corresponding instruction) via an application, such as an app installed on a smartphone.

### SUMMARY

Aspects of the present invention disclose a method, computer program product, and system for determining and providing information to users in a queue at an ATM based on actual and estimated resource usage of the ATM. The method includes one or more processors identifying a plurality of users in a queue at an automated teller machine (ATM). The method further includes determining historical ATM usage information associated with the identified plurality of users in the queue at the ATM. The method further includes determining respective ATM transaction estimates for the plurality of users in the queue at the ATM based on the determined historical ATM usage information. The method further includes determining respective transaction completion probabilities for the identified plurality of users completing the respective ATM transaction estimates based on a current resource supply of the ATM and the determined historical ATM usage information of the plurality of users in the queue at the ATM.

In another embodiment, the method further includes sending a notification to users of the plurality of users in the queue at the ATM that have a corresponding respective transaction completion probability below a threshold value.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for determining and providing information to users in a queue at an ATM based on actual and estimated resource usage of the ATM, in accordance with an embodiment of the present invention.

FIG. 3 is an example depiction of a table that includes information associated with users in a queue at an ATM, in accordance with an embodiment of the present invention.

FIG. 4 depicts a block diagram of components of a computing system representative of the computing devices and server of FIG. 1, in accordance with an embodiment of the present invention.

### DETAILED DESCRIPTION

Embodiments of the present invention allow for determining and providing information to users in a queue at an automated teller machine (ATM) based on actual and estimated resource usage of the ATM. Various embodiments of the present invention identify users that are in a queue at an ATM and determine transaction estimates for the identified users based on historical information and real-time information associated with the ATM and the identified users. In additional embodiments of the present invention, based on resource supply information of the ATM, transaction completion probabilities are determined for the identified users in the queue. In response to determining that a transaction completion probability is below a threshold value, embodiments of the present invention notify corresponding users.

Some embodiments of the present invention provide improvements by providing ATM recommendations to user based on resource supply (e.g., money, paper, etc.) and predictive analytics. Embodiments of the present invention can operate to distribute the resource utilization across ATMs based on real-time analysis of demand, which reduces downtime of a distributed ATM network and also significantly increases availability and efficiency.

Implementation of embodiments of the invention may take a variety of forms, and exemplary implementation details are discussed subsequently with reference to the Figures.

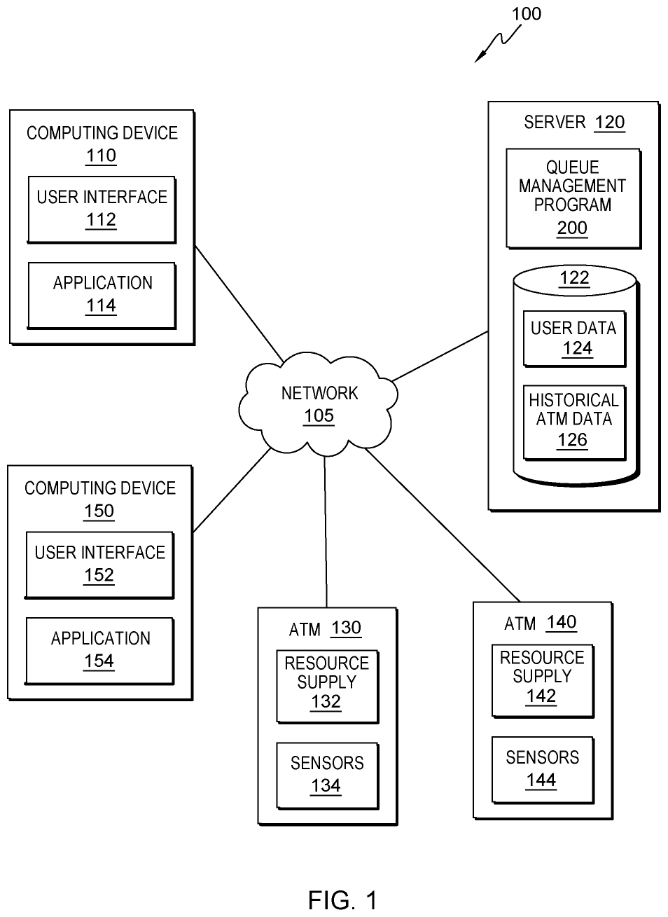

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes computing device 110, server 120, ATM 130, ATM 140, and computing device 150, all interconnected over network 105. In an example embodiment, respective individuals associated with and/or utilizing computing device 110 and computing device 150 are in a queue at one or more of ATM 130 and ATM 140. In this example embodiment, server 130 can provide a recommendation to utilize ATM 130 or ATM 140 to computing device 110 or computing device 150, in accordance with various embodiments of the present invention.

Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between computing device 110, server 120, ATM 130, ATM 140, and computing device 150, in accordance with embodiments of the present invention. In various embodiments, network 105 facilitates communication among a plurality of networked ATMs (e.g., ATM 130 and ATM 140), corresponding users (e.g., an individual utilizing computing device 110 and/or computing device 150), and corresponding management services (e.g., server 120).

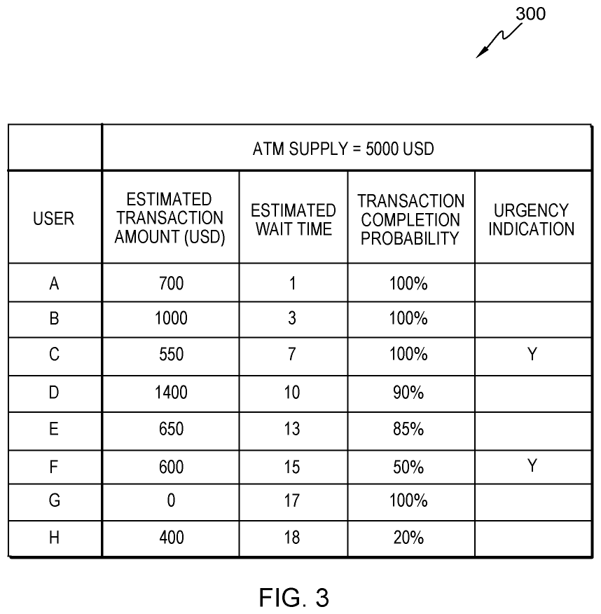

In various embodiments of the present invention, computing device 110 and computing device 150 may be a workstation, personal computer, personal digital assistant, mobile phone, or any other device capable of executing computer readable program instructions, in accordance with embodiments of the present invention. In general, computing device 110 and computing device 150 are representative of any electronic device or combination of electronic devices capable of executing computer readable program instructions. Computing device 110 and computing device 150 may include components as depicted and described in further detail with respect to FIG. 3, in accordance with embodiments of the present invention. In an example embodiment, computing device 110 and computing device 150 are smart devices, such as a smartphone, a smart watch, etc.

Computing device 110 includes user interface 112 and application 114. User interface 112 is a program that provides an interface between a user of computing device 110 and a plurality of applications that reside on the computing device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on computing device 110. In an example embodiment, application 114 is a client-side application of an enterprise associated with server 120, ATM 130, and ATM 140. In another example embodiment, application 114 is a web browser that an individual utilizing computing device 110 utilizes (e.g., via user interface 112) to access information over network 105, such as services associated with ATM 130 and ATM 140 or provided by an enterprise associated with server 120. In other aspects of the present invention, application 114 can be representative of applications that provide additional functionality (e.g., camera, messaging, etc.), in accordance with various aspects of the present invention.

In additional aspects of the present invention, computing device 150 includes user interface 152 and application 154. The respective instances of user interface 152 and application 154 include functionality as described above, with regard to respective instances of user interface 112 and application 114. In an example embodiment, computing device 110 and computing device 150 are smartphones in possession of users that in a queue at ATM 130.

In example embodiments, server 130 can be a desktop computer, a computer server, or any other computer systems, known in the art. In certain embodiments, server 130 represents computer systems utilizing clustered computers and components (e.g., database server computers, application server computers, etc.) that act as a single pool of seamless resources when accessed by elements of data processing environment 100 (e.g., computing device 110, ATM 130, ATM 140, and computing device 150). In general, server 120 is representative of any electronic device or combination of electronic devices capable of executing computer readable program instructions. Server 120 may include components as depicted and described in further detail with respect to FIG. 3, in accordance with embodiments of the present invention.

Server 120 includes queue management program 200 and storage device 122, which includes user data 124 and historical ATM data 126. In one embodiment, server 120 is associated with a particular enterprise (e.g., a business or financial institution) that manages a network of ATMs, including ATM 130 and ATM 140. In one embodiment, queue management program 200 determines and provides information to users in a queue at an ATM based on actual and estimated resource usage of the ATM, in accordance with embodiments of the present invention.

Storage device 122 can be implemented with any type of storage device, for example, persistent storage 305, which is capable of storing data that may be accessed and utilized by server 120, computing device 110, ATM 130, ATM 140, and computing device 150, such as a database server, a hard disk drive, or a flash memory. In other embodiments, storage device 122 can represent multiple storage devices and collections of data within server 120. In various embodiments, storage device 122 includes information that queue management program 200 can access and utilize, in accordance with embodiments of the present invention. Storage device 122 includes user data 124 and historical ATM data 126.

In example embodiments, user data 124 includes information associated with registered users of an enterprise that manages ATM 130 and ATM 140 (e.g., a financial institution). For example, an individual utilizing computing device 110 completes a registration process, provides information, and authorizes the collection and analysis (i.e., opts-in) of data associated with the individual, by server 130 (e.g., via queue management program 200). In this example, the individual can authorize server 120 to utilize a camera of an ATM to identify the individual and also authorize server 120 to monitor transaction information of the individual to determine a transaction plan. In other examples, the individual can provide authorization of a subset of categories of data collection (i.e., opt-in out of certain categories of data collection).

In one embodiment, user data 124 includes user profile information for respective users, such as user identification information. For example, user data 124 includes an image, or other user-provided biometric information, that server 130 can utilize to identify a user (e.g., in reference to real-time camera information from an ATM, such as from sensors 134 and sensors 144, for facial recognition). In another embodiment, user data 124 includes information associated with how respective users utilize ATMs. For example, user data 124 includes a favorite and/or normal withdrawal amount and a withdrawal pattern associated with the individual utilizing computing device 110.

In a further embodiment, user data 124 includes a transaction plan, and corresponding information, for a user, such as an individual utilizing computing device 110. The transaction plan includes a schedule of transactions of the user (i.e., spending and withdrawing money) based on historical data and user-provided information. In other embodiments, user data 124 includes additional information associated with use of an ATM, such as user card health information, user-provided calendar information, user access profile information (e.g., ATM accessibility requirements). User data 124 can also include user preference information, such as a user preferred ATM (e.g., ATM 130), user notification preferences, user-provided scheduling information, etc.

In an additional embodiment, user data 124 can also include a combination of historical information associated with a user and currently gathered real-time information of the user (e.g., from sensors 134 and sensors 144). User data 124 can also, in response to a user approval (e.g., during registration), include urgency information associated with a user, such as a maximum preferred wait time, user-provided scheduled events, a frequency that the users leaves an ATM queue without completing a transaction, etc.

In various embodiments, historical ATM data 126 includes historical usage information for specific ATMs managed by server 120 (e.g., ATM 130 and ATM 140), in accordance with embodiments of the present invention. For example, historical ATM data 126 includes respective historical transaction information for a specific ATM, such as ATM 130. In additional embodiments, historical ATM data 126 includes information that queue management program 200 to determine transaction completion probabilities for users in a queue at an ATM, in accordance with various embodiments of the present invention.

ATM 130 and ATM 140 are representative of automated teller machines that are associated with an enterprise associated with server 120, in accordance with embodiments of the present invention. In an example embodiment, an individual utilizing computing device 110 is registered to utilize ATM 130 and ATM 140 (e.g., is a member of a corresponding financial institution). In various embodiments, ATM 130 and ATM 140 are part of a network of ATMs (e.g., a plurality of ATMs associated with a particular financial institution), which are manages by server 120, in accordance with various embodiments of the present invention. ATM 130 and ATM 140 include respective instances of resources supplies (i.e., resource supply 132 and resource supply 142) and sensors (i.e., sensors 134 and sensors 144).

In one embodiment, resource supply 132 and resource supply 142 include information indicating an amount of resources that a respective instance of ATM 130 and ATM 140 contain. In an example scenario, the resources include a supply of cash contained within an ATM, which is updated in response to each transaction at an ATM. In another scenario, the resources can also include an amount of receipt paper, or other quantifiable resource, contained within an ATM.

In example embodiments, sensors 134 and sensors 144 includes cameras and other sensors (e.g., microphone, etc.), associated with a respective instance of ATM 130 and ATM 140, that server 130 can access and utilize in accordance with various embodiments of the present invention. Embodiments of the present invention utilize sensors 134 and sensors 144 to gather user-authorized information for users of ATM 130 and ATM 140. For example, server 120 can utilize a camera, of sensors 134, to perform facial recognition on an individual utilizing computing device 110 to identify the individual while in line at ATM 130, when the individual has authorized facial recognition identification (e.g., in user data 124). In another embodiment, server 120 can access a camera, of sensors 134, at ATM 130 to identify a length of a queue at ATM 130.

In an additional embodiment, sensors 134 and sensors 144 can monitor respective instances of resource supply 132 and resource supply 142 and convey corresponding data to server 120. In a further example, server 120 can utilize sensors of an ATM to identify a user that is in proximity to an ATM to predict whether the user is a potential customer for the ATM. In another embodiment, sensors 134 ad sensors 144 can includes sensors that monitor a heath of a card provided by a user, to determine whether a failed transaction is the result of a damaged card. In this embodiment, server 120 can provide a notification to the user corresponding to the damaged card.

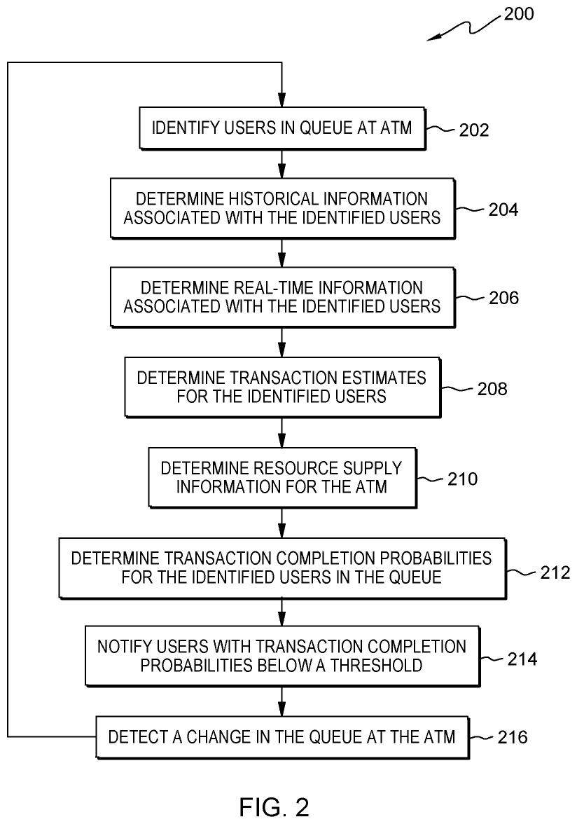

FIG. 2 is a flowchart depicting operational steps of queue management program 200, a program for determining and providing information to users in a queue at an ATM based on actual and estimated resource usage of the ATM, in accordance with embodiments of the present invention. In various embodiments, queue management program 200 operates (e.g., as a continuous background process during operation of an ATM) to monitor and analyze registered users (e.g., a user, a plurality of user, or all users) that are in a queue at an ATM.

In one embodiment, queue management program 200 initiates periodically to analyze users in queue at an ATM. In another embodiment, queue management program 200 initiates in response to receiving new information, such as a change in the queue at an ATM, a user potentially entering the ATM queue, an update to resource information associated with an ATM (e.g., resource supply 132), etc. In other embodiments, queue management program 200 can operate to concurrently analyze a plurality of users in a queue, or each user individually (e.g., as a separate instance of queue management program 200).

In step 202, queue management program 200 identifies users in queue at an ATM. In one embodiment, queue management program 200 utilizes sensors 134 (e.g., a camera) to identify a plurality of users that are in queue at ATM 130. In various embodiments, queue management program 200 identifies users in the ATM queue that are registered with server 130 and have authorized queue management program 200 to collect and analyze data associated with the users (i.e., through registered preferences in user data 124). In an alternate embodiment, a user can opt-out of analysis by queue management program 200, and accordingly, can proceed without collecting data corresponding to said users (e.g., replacing the user with a default profile, etc.).

In an example embodiment, queue management program 200 can determine respective identities of users in the ATM queue utilizing facial recognition technology and data from sensors of the ATM (e.g., sensors 134). Upon determining an identity of a user, queue management program 200 can retrieve a corresponding user data record from user data 124. In another example embodiment, queue management program 200 communicate with a user in queue at an ATM to determine identification information for the user. For example, queue management program 200 sends a message or notification to an individual utilizing computing device 110, utilizing application 114, to solicit identification information and information associated with a transaction, to which the user can optionally respond. In this example, queue management program 200 can send a message to a user upon determining that the user is within a threshold distance to the ATM (e.g., a distance, within wireless communication range, detectable by a sensor or camera, etc.). In an additional embodiment, queue management program 200 can utilize a combination of facial recognition and communications to determine identities of users in a queue at the ATM.

FIG. 3 depicts example table 300, an example depiction of a table that includes information associated with users in a queue at ATM 130, in accordance with an embodiment of the present invention. In the depicted embodiment, example table 300 indicates that at the depicted point in time, ATM 130 includes a cash supply of $5000 USD (i.e., in resource supply 132). Example table 300 includes rows that correspond to each user in queue at ATM 130 (i.e., users A through H). Further, example table includes columns that indicate, for each respective user in queue, an estimated transaction amount (in USD), an estimated wait time, a transaction completion probability, and an optional indication of urgency of the user. In example embodiments, queue management program 200 utilizes sensors 134 of ATM 130 to determine identification information for users A through H, which are in queue at ATM 130. Queue management program 200 can then fetch relevant information for the user from user data 124 (e.g., favorite withdrawal amount, account details, user preferences, etc.).

In step 204, queue management program 200 determines historical information associated with the identified users. In one embodiment, queue management program 200 fetches information from user data 124 for users identified to be in queue at ATM 130 (in step 202), which includes historical information associated with the identified users. In various embodiments, queue management program 200 derives historical information associated with users from respective instances of user data 124. For example, the historical information can include one or more of: a favorite or average withdrawal amount (i.e., expected withdrawal amount), account information, historical user ATM usage information, user queue behavior information (e.g., on average the user leaves a queue after five minutes), user preference information, user-provided and/or historical urgency information (e.g., scheduled events, etc.), etc.

In an example scenario, queue management program 200 identifies a user in queue at ATM 130 (in step 202) and determines historical information associated with the user through parsing a relevant information in user data 124. In this scenario, the historical information of user data 124 includes an indication of a “favorite” withdrawal amount of $250 and user-provided urgency information (e.g., the user has a recurring meeting or appointment every Thursday at noon). In alternate scenarios, queue management program 200 can determine different amounts and/or categories of historical information (e.g., based on user preferences), or queue management program 200 can determine that no historical information is available for the user.

In step 206, queue management program 200 determines real-time information associated with the identified users. In various embodiments, queue management program 200 can determine real-time information from one or more of a plurality of data sources, including user data 124, interactions with users (e.g., user-provided information via application 114, user responses to messages, etc.), urgency indications, data received from the ATMs (e.g., from sensors 134). In other embodiments, queue management program 200 can utilize the determined historical information (from step 204) when determining real-time information (e.g., determine real-time information in categories that are associated with the determined historical information).

In additional embodiments, queue management program 200 can determine real-time information of whether new users are forecast to join the queue soon (e.g., a user is in proximity and looks in the direction of ATM 130, user data 124 indicates a user is approaching an predicted transaction with ATM 130 based on transaction plans, users requesting use of ATM 130 via a mobile application, etc.). In a further embodiment, queue management program 200 dynamically collects real-time information based on changes in conditions, such as a change in withdrawal amount, a change in favorite ATM, change in queue, etc.

In an example scenario, queue management program 200 identifies a user (utilizing computing device 110) in queue at ATM 130 (in step 202) and determines real-time information based on data from sensors 134 and information that the user input into application 114. In this scenario, queue management program 200 analyzes images from a camera of sensors 134 and determines an urgency associated with the user (e.g., based on body language, the user looking at their watch, talking on the phone, wearing a uniform, facial expressions, etc.). Queue management program 200 can also reference user data 124 and user-provided information to determine urgency information (e.g., calendar information, places visited, user messages that indicate urgency, user-indicated time constraints, etc.). In this scenario, queue management program 200 determines the indications of urgency associated with the user, in addition to other real-time information discussed above. For example, example table 300 depicts that queue management program 200 has determined that user C and user F are associated with an indication of urgency.

In step 208, queue management program 200 determines transaction estimates for the identified users. In one embodiment, queue management program 200 determines transaction estimates for the identifies users in the queue (from step 202) based on the corresponding determined historical information (from step 204) and the determined real-time information (in step 206). In an example embodiment, queue management program 200 determines the transaction estimates to include an estimated monetary denomination requirement a user to complete an intended transaction. In another example embodiment, queue management program 200 determines a transaction estimate that does not include withdrawing money (e.g., checking an account balance, deposit transaction, etc.).

In one example scenario, queue management program 200 determines transaction estimates for the users to correspond to determined favorite withdrawal amounts for the users (e.g., derived from respective instances of user data 124 in step 204). In another example scenario, queue management program 200 determines transaction estimates for the users to correspond to user-provided monetary denomination requirements for an ATM withdrawal (e.g., user-provided information via application 114, user responses to messages, real-time information derived in step 206, etc.). In a further example scenario, queue management program 200 solicit a requested monetary denomination for an ATM transaction from a user, if not received previously, to determine a transaction estimate. In yet another scenario, queue management program 200 can analyze historical user transaction data (e.g., from user data 124) to determine an estimate for an ATM transaction (e.g., a most frequent monetary denomination, correlate the current time to previous ATM activity of the user, based on a withdrawal pattern, etc.

In the depicted example embodiment of FIG. 3, example table 300 includes the “Estimated Transaction Amount (USD)” column, which queue management program 200 populates for respective users with information determined in step 208. For example, queue management program 200 determines that user B has provided input indicating a intended ATM withdrawal of $1000 (via input into an application), user E is associated with a favorite withdrawal amount of $650, determines an estimated withdrawal amount of $600 for user F based on historical transaction data, and determines that user G is not making a cash withdrawal from ATM 130 (i.e., monetary denomination requirement of $0) and ins instead checking an account balance (e.g., determined based on historical information or user-provided real-time information).

In step 210, queue management program 200 determines a resource supply for the ATM. In one embodiment, queue management program 200 determines an amount of cash in ATM 130 by accessing and/or analyzing resource supply 132. In other embodiments, queue management program 200 determines quantities of each resource included in an ATM, such as cash, receipt paper, envelopes, power, etc. In the depicted example embodiment of FIG. 3, example table 300 includes an indication of an initial ATM supply of $5000.

In step 212, queue management program 200 determines transaction completion probabilities for the identified users in the queue. In one embodiment, queue management program 200 determines transaction completion probabilities for the identified users in the queue (from step 202) based on one or more of: corresponding determined historical information (from step 204), the determined real-time information (in step 206), the determined transaction estimates (from step 208), and the determined resource supply of the ATM (step 210). In various embodiments, a transaction completion probability is representative of the probability that a respective user will successfully compete an intended transaction (i.e., fulfill transaction at ATM 130) prior to leaving the queue at the ATM (before or after attempting a transaction).

In another embodiment, queue management program 200 determines the probability that a user will complete an intended transaction (e.g., withdraw cash) at an ATM based on urgency indications of users in the queue (e.g., a corresponding chance, based on historical information in user data 124, that indicates may leave the queue prior to completing a transaction). In additional embodiment, queue management program 200 can also determine probabilities based on a health of an access card associated with the user and a probability of additional users joining the ATM queue (e.g., based in data in historical ATM data 126). In various embodiments, queue management program 200 can identify which users in the queue have registered authorization to queue management program 200, and then determine transaction completion probabilities for users in the queue accordingly.

In the depicted example embodiment of FIG. 3, example table 300 includes the “Transaction Completion Probability” column, which queue management program 200 populates for respective users with information determined in step 212. Additionally, example table 300 includes the “Urgency Indication” column, which queue management program 200 populates for respective users with information (e.g., Yes, No, leave blank, etc.) indicating whether the respective user is associated with urgency information (e.g., calendar information, places visited, user messages that indicate urgency, user-indicated time constraints, etc.).

With regard to example table 300, which includes an example depiction of a table that includes information associated with users in a queue at ATM 130, the monetary resource supply of ATM 130 is $5000 (e.g., the contents of resource supply 132). In one scenario, queue management program 200 determines a 100% transaction completion probability for user A, based on at least the user's position in the queue (i.e., first), ATM cash supply, estimated withdrawal amount of $700, and historical information associated with the user (e.g., historical withdrawal amounts). In various embodiments, the historical information that queue management program 200 utilizes includes entries corresponding to previous transaction amounts, which queue management program 200 can utilize to determine a probability that the user with withdraw a monetary amount that is greater than the current ATM supply (based on previous probabilities).

In another scenario, queue management program 200 determines an 85% transaction completion probability for user E, based on at least the estimated transactions of users A through E in relation to the ATM supply, indications of urgency of users A through E (e.g., a probability that a user will leave the queue early, taking into account wait time), and historical information. In further embodiments, queue management program 200 can determine and/or utilize an associated confidence value associated with an estimated transaction amount in determining a transaction completion probability (e.g., a high confidence for a user-provided transaction amount in relation to an estimated amount based on historical ATM usage, etc.). In various embodiments of the present invention, queue management program 200 utilizes historical probabilities of events (e.g., previous ATM transactions), from user data 124 and historical ATM data 126, to determine the respective transaction completion probabilities.

In other scenarios, queue management program 200 can determine a transaction completion probability for a user prior to the user joining an ATM queue. In such scenarios, queue management program 200 can determine a forecast number of users that will join (buy have not yet joined) the ATM queue prior to the user, and corresponding transaction estimates for the forecast number of users. Queue management program 200 can then also utilize the transaction estimates for the users already in the ATM queue to determine a transaction completion probability for the user (who is yet to join the queue) at the predicted time for the user's ATM transaction. For example, the probability of users joining the queue and the corresponding estimated ATM transactions can change the probability that a later arriving user can complete a ATM transaction.

In step 214, queue management program 200 notifies users with a transaction completion probability below a threshold. In one embodiment, queue management program 200 notifies users in queue at ATM 130 that have a corresponding transaction completion probability (determined in step 212) that is below a defined threshold percentage value. Queue management program 200 can utilize threshold defined by a system (e.g., server 120, ATM 130, etc.), a user-specific threshold that is defined by specific users (e.g., a user defines a threshold to be below 50%), or a combination thereof (system threshold for some users and user-defined threshold for other users). In an example embodiment, queue management program 200 sends a notification to a corresponding application on a device associated with a user (e.g., application 113 of computing device 110). In various embodiments, queue management program 200 provides notifications to users according to user defined preferences. For example, users with an associated or user-provided indication of urgency can receive notification sooner (e.g., at a higher transaction completion probability, or if the estimated wait time exceeds a certain time limit, etc.).

In example embodiments, queue management program 200 can provide notifications that include a recommended alternate ATM that the user can visit (e.g., based on a location and resource supply of candidate alternate ATMs, ATM accessibility requirements provided by a user, etc.). For example, queue management program 200 determines (from example table 300) that user F has a transaction completion probability of 50%, an estimated wait time of fifteen minutes, and an indication of urgency. Queue management program 200 can determine that ATM 140 is located on an upcoming travel route of user F (based on data that user F provided in user data 124) and is forecast to have sufficient cash in resource supply 142. Accordingly, queue management program 200 can provide a notification to application 154 on computing device 150 (e.g., a smart watch of user F) that, based on the queue of users and estimated transactions at ATM 130, user F can complete a transaction at ATM 140. Alternatively, user B does not receive a notification, due to the wait time of three minutes and the 100% estimated transaction completion probability.

In another example embodiment, queue management program 200 can provide a notification and/or message to a computing device associated with user G to facilitate the transaction of user G without requiring use of the ATM. For example, queue management program 200 can provide user G with instructions on how to check an account balance (or other transaction) utilizing an application on a computing device (e.g., a smartphone of the user), instead of waiting in the queue at ATM 130. In additional embodiments, queue management program 200 can utilize user-provided (or authorized) information to identify users that have upcoming transactions (not including withdrawals at an ATM) that can be accomplished without cash (i.e., cashless transactions). In these embodiments, queue management program 200 can provide notifications of vendors that can execute the cashless transactions for the users (e.g., based on user travel route information, etc.).

In step 216, queue management program 200 detects a change in the queue at the ATM. In one embodiment, queue management program 200 detects that a user has completed a transaction at ATM 130. In another embodiment, queue management program 200 detects that a user has left the queue at ATM 130 prior to completing a transaction (e.g., user F leaves the queue to proceed to ATM 140). In yet another embodiment, queue management program 200 detects that a user is joined the queue at ATM 130.

In response to detecting a change in the queue at the ATM, queue management program 200 loops to step 202, to identify the users that are currently in queue at the ATM. In another embodiment, in response to detecting a change in the queue, queue management program 200 updates corresponding instances of one or more of user data 124 (e.g., corresponding to the user that has completed a transaction or left the queue) and historical ATM data 126 (e.g., based on a completed transaction at the respective ATM). In various embodiments of the present invention, queue management program 200 can detect a change in the queue at any point in the process and either loop back to step 202, complete processing and then loop to step 202, or terminate and reinitiate.

Various embodiments of the present invention provide a plurality of advantages through actively managing the queue of users at an ATM, including reducing downtime in a networked ATM system, and also facilitating a distribution of a workload across ATMs in a networked environment. In further embodiments, queue management program 200 can reduce ATM workloads by facilitating resolution of transactions that do not require use of the ATM (e.g., checking account balance, etc.). Embodiments of the present recognize that the real-time and proactive management of ATM queues increases the frequency of successfully completed ATM transactions for an enterprise, and also increases ATM availability by directing users to ATMs that can successfully complete transactions (reducing ATM overload and corresponding downtime).

FIG. 3 depicts example table 300, an example depiction of a table that includes information associated with users in a queue at ATM 130, in accordance with an embodiment of the present invention. In the depicted embodiment, example table 300 indicates that at the depicted point in time, ATM 130 includes a cash supply of $5000 USD (i.e., in resource supply 132). Example table 300 includes rows that correspond to each user in queue at ATM 130 (i.e., users A through H). Further, example table includes columns that indicate, for each respective user in queue, an estimated transaction amount (in USD), an estimated wait time, a transaction completion probability, and an optional indication of urgency of the user

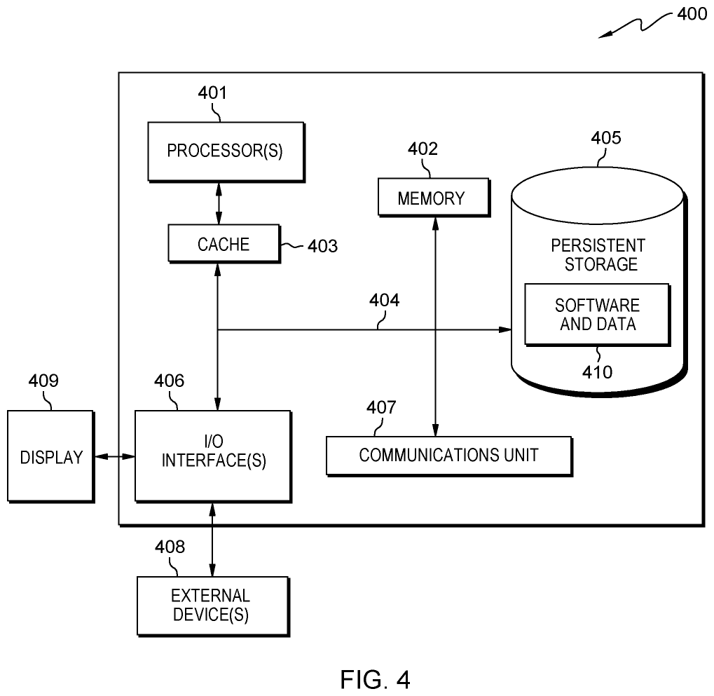

FIG. 4 depicts computer system 400, which is representative of computing device 110, server 120, and computing device 150, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to computing device 110, software and data 410 is representative of user interface 112 and application 114. With respect to server 120, software and data 410 is representative of queue management program 200, user data 124, and historical ATM data 126. With respect to computing device 150, software and data 410 is representative of user interface 152 and application 154.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, a plurality of users in a queue at an automated teller machine (ATM);
determining, by one or more processors, historical ATM usage information associated with the identified plurality of users in the queue at the ATM;
determining, by one or more processors, respective ATM transaction estimates for the plurality of users in the queue at the ATM based on the determined historical ATM usage information; and
determining, by one or more processors, respective transaction completion probabilities for the identified plurality of users completing the respective ATM transaction estimates based on a current resource supply of the ATM and the determined historical ATM usage information of the plurality of users in the queue at the ATM.

2. The method of claim 1, further comprising:
sending, by one or more processors, a notification to users of the plurality of users in the queue at the ATM that have a corresponding respective transaction completion probability below a threshold value.

3. The method of claim 1, wherein determining respective ATM transaction estimates for the plurality of users in the queue at the ATM further comprises:
determining, by one or more processors, real-time information associated with at least one user of the plurality of users in the queue at the ATM, wherein the real-time information includes a user-provided ATM withdrawal amount; and
determining, by one or more processors, the respective ATM transaction estimates for the plurality of users in the queue at the ATM based on the determined historical ATM usage information and the determined real-time information.

4. The method of claim 1, wherein determining respective ATM transaction estimates for the plurality of users in the queue at the ATM further comprises:
determining, by one or more processors, urgency information associated with at least one user of the plurality of users in the queue at the ATM, wherein the urgency information is selected from the group consisting of: a maximum preferred wait time, user-provided scheduled events, a frequency that the at least one user leaves an ATM queue without completing a transaction, and real-time indications of urgency; and
determining, by one or more processors, the respective ATM transaction estimates for the plurality of users in the queue at the ATM based on the determined historical ATM usage information and the determined urgency information.

5. The method of claim 1, wherein determining historical ATM usage information associated with the identified plurality of users further comprises:
determining, by one or more processors, an identity of a first user of the plurality of users in the queue at the ATM utilizing facial recognition; and
retrieving, by one or more processors, a data record that corresponds to the first user, wherein the determined data record indicates historical ATM usage information for the first user, wherein the historical ATM usage information includes historical ATM transactions, user preferences, and an expected withdrawal amount.

6. The method of claim 1, further comprising:
in response to detecting a change to the identified plurality of users in the queue at the ATM, determining, by one or more processors, an updated plurality of users in the queue at the ATM.

7. The method of claim 1, wherein determining respective transaction completion probabilities for the identified plurality of users completing the respective ATM transaction further comprises:
determining, by one or more processors, a usage condition indicating a health of an ATM access card of a user of the plurality of users in the queue at the ATM; and
determining, by one or more processors, the respective transaction completion probability for the user based on the current resource supply of the ATM and the determined historical ATM usage information of the user, and the determined usage condition of the ATM access card.

8. A computer program product comprising:
one or more computer readable storage media and program instructions stored on the one or more computer readable storage media, the program instructions comprising:
program instructions to identify a plurality of users in a queue at an automated teller machine (ATM);
program instructions to determine historical ATM usage information associated with the identified plurality of users in the queue at the ATM;
program instructions to determine respective ATM transaction estimates for the plurality of users in the queue at the ATM based on the determined historical ATM usage information; and
program instructions to determine respective transaction completion probabilities for the identified plurality of users completing the respective ATM transaction estimates based on a current resource supply of the ATM and the determined historical ATM usage information of the plurality of users in the queue at the ATM.

9. The computer program product of claim 8, further comprising program instructions, stored on the one or more computer readable storage media, to:
send a notification to users of the plurality of users in the queue at the ATM that have a corresponding respective transaction completion probability below a threshold value.

10. The computer program product of claim 8, wherein the program instructions to determine respective ATM transaction estimates for the plurality of users in the queue at the ATM further comprise program instructions to:
determine real-time information associated with at least one user of the plurality of users in the queue at the ATM, wherein the real-time information includes a user-provided ATM withdrawal amount; and
determine the respective ATM transaction estimates for the plurality of users in the queue at the ATM based on the determined historical ATM usage information and the determined real-time information.

11. The computer program product of claim 8, wherein the program instructions to determine respective ATM transaction estimates for the plurality of users in the queue at the ATM further comprise program instructions to:
determine urgency information associated with at least one user of the plurality of users in the queue at the ATM, wherein the urgency information is selected from the group consisting of: a maximum preferred wait time, user-provided scheduled events, a frequency that the at least one user leaves an ATM queue without completing a transaction, and real-time indications of urgency; and
determine the respective ATM transaction estimates for the plurality of users in the queue at the ATM based on the determined historical ATM usage information and the determined urgency information.

12. The computer program product of claim 8, wherein the program instructions to determine historical ATM usage information associated with the identified plurality of users further comprise program instructions to:
determine an identity of a first user of the plurality of users in the queue at the ATM utilizing facial recognition; and
retrieve a data record that corresponds to the first user, wherein the determined data record indicates historical ATM usage information for the first user, wherein the historical ATM usage information includes historical ATM transactions, user preferences, and an expected withdrawal amount.

13. The computer program product of claim 8, further comprising program instructions, stored on the one or more computer readable storage media, to:
in response to detecting a change to the identified plurality of users in the queue at the ATM, determine an updated plurality of users in the queue at the ATM.

14. A computer system comprising:
one or more computer processors;
one or more computer readable storage media; and
program instructions stored on the computer readable storage media for execution by at least one of the one or more processors, the program instructions comprising:
program instructions to identify a plurality of users in a queue at an automated teller machine (ATM);
program instructions to determine historical ATM usage information associated with the identified plurality of users in the queue at the ATM;
program instructions to determine respective ATM transaction estimates for the plurality of users in the queue at the ATM based on the determined historical ATM usage information; and
program instructions to determine respective transaction completion probabilities for the identified plurality of users completing the respective ATM transaction estimates based on a current resource supply of the ATM and the determined historical ATM usage information of the plurality of users in the queue at the ATM.

15. The computer system of claim 14, further comprising program instructions, stored on the computer readable storage media for execution by at least one of the one or more processors, to:
send a notification to users of the plurality of users in the queue at the ATM that have a corresponding respective transaction completion probability below a threshold value.

16. The computer system of 14, wherein the program instructions to determine respective ATM transaction estimates for the plurality of users in the queue at the ATM further comprise program instructions to:
determine real-time information associated with at least one user of the plurality of users in the queue at the ATM, wherein the real-time information includes a user-provided ATM withdrawal amount; and
determine the respective ATM transaction estimates for the plurality of users in the queue at the ATM based on the determined historical ATM usage information and the determined real-time information.

17. The computer system of claim 14, wherein the program instructions to determine respective ATM transaction estimates for the plurality of users in the queue at the ATM further comprise program instructions to:
determine urgency information associated with at least one user of the plurality of users in the queue at the ATM, wherein the urgency information is selected from the group consisting of: a maximum preferred wait time, user-provided scheduled events, a frequency that the at least one user leaves an ATM queue without completing a transaction, and real-time indications of urgency; and
determine the respective ATM transaction estimates for the plurality of users in the queue at the ATM based on the determined historical ATM usage information and the determined urgency information.

18. The computer system of claim 14, wherein the program instructions to determine historical ATM usage information associated with the identified plurality of users further comprise program instructions to:
determine an identity of a first user of the plurality of users in the queue at the ATM utilizing facial recognition; and
retrieve a data record that corresponds to the first user, wherein the determined data record indicates historical ATM usage information for the first user, wherein the historical ATM usage information includes historical ATM transactions, user preferences, and an expected withdrawal amount.

19. The computer system of claim 14, further comprising program instructions, stored on the computer readable storage media for execution by at least one of the one or more processors, to:
in response to detecting a change to the identified plurality of users in the queue at the ATM, determine an updated plurality of users in the queue at the ATM.

20. The computer system of claim 14, wherein the program instructions to determine respective transaction completion probabilities for the identified plurality of users completing the respective ATM transaction users further comprise program instructions to:
determine a usage condition indicating a health of an ATM access card of a user of the plurality of users in the queue at the ATM; and
determine the respective transaction completion probability for the user based on the current resource supply of the ATM and the determined historical ATM usage information of the user, and the determined usage condition of the ATM access card.
